(19) United States
(12) Patent Application Publication
(10) Pub. No.: US 2013/0163828 A1
(43) Pub. Date: Jun. 27, 2013

(54) OBJECT WHICH CAN BE AUTHENTICATED AND WHICH CONTAINS A COVER MASKING AN AUTHENTICATING PATTERN

(71) Applicant: Commissariat A L'Energie Atomique Et Aux Energies Alternatives, Paris (FR)

(72) Inventor: Anne-Laure SEILER, Seyssinet Pariset (FR)

(73) Assignee: Commissariat A L'Energie Atomique Et Aux Energies Alternatives, Paris (FR)

(21) Appl. No.: 13/777,039

(22) Filed: Feb. 26, 2013

Related U.S. Application Data
(63) Continuation of application No. PCT/EP2011/060998, filed on Jun. 30, 2011.

(30) Foreign Application Priority Data
Sep. 10, 2010 (FR) 10.57187

(51) Int. Cl. G06K 9/00; B44F 1/10

(52) U.S. Cl. 382/112; 283/33; 428/29

(57) ABSTRACT

An object which can be authenticated includes a substrate containing at least one authenticating or identification pattern. The pattern is covered by a cover for masking and exposing the pattern. The pattern is fluorescent and comprises organic fluorescent particles and/or inorganic fluorescent particles included in the substrate. The cover can be physically or structurally deformed in order to expose the pattern.

### FIELD OF THE INVENTION

The present invention relates to an object which can be authenticated comprising a cover enabling to mask and to expose an authenticating pattern.

The field of use of the present invention especially relates to the fight against counterfeiting of documents or of protected products.

### BACKGROUND

Many means enable to fight against the illicit copying of documents or of various products, such as for example, the incorporation of fluorescent markers in different media (plastic, paper . . . ). However, the detection and the recognition of these devices is often easy and a poor deterrent for an experienced counterfeiter. Indeed, in certain cases, it is relatively easy to thwart anti-counterfeiting systems. Thus, the protection implementing the detection of a fluorescent particle emission spectrum may turn out to be insufficient.

Document U.S. Pat. No. 6,061,122 describes a system having its authenticity determined by recognition of the optical properties of cholesteric liquid crystals used in its manufacturing. Such liquid crystals can reflect light at certain wavelengths and thus enable to form holographic-type images which are difficult to copy.

Document US 2003/0173539 describes a marking, comprising liquid crystals, invisible to the eye but capable of being detected by means of a detection device such as a polarizer or a color filter.

Document U.S. Pat. No. 6,580,481 describes a device comprising visible inscriptions and invisible inscriptions. The invisible inscriptions are recorded on a magnetic layer whereon the information can only be recorded once or in the memory of an integrated circuit where the information can be recorded and erased. A detection device makes invisible inscriptions visible.

Such devices thus require special equipment to recover or to expose the hidden information or the non-hidden information, but which are difficult to copy.

Devices especially enabling to conceal such markers have thus been developed. The detection device then reads the markers after having deactivated the locking system concealing said markers.

Thus, document US 2006/0126001 discloses a device wherein an anti-counterfeiting pattern to be detected is incorporated in a material. Such a device has two different states, one enabling to conceal the anti-counterfeiting pattern and the other enabling to detect it. Thus, first, the material has to be made “transparent” to the detection light, before proceeding to the actual reading of the pattern. While remaining difficult to duplicate, the anti-counterfeiting pattern of this device is made visible to the human eye without the need for specialized detection devices. In this device, the material comprises two stable states, it also contains the anti-counterfeiting pattern. It is also important to note that this device may pose problems of compatibility between the materials forming the pattern and those forming the cover.

Most of the above-described devices enable to protect, for example, documents against any counterfeiting by means of scanners, photocopiers, spectrometers, and others. They also require a specific detection device for exposing the marking patterns.

Document WO 82/02445 describes an identifiable article comprising a distinctive element such as a photograph. A mask, generally opaque, permanently covers the distinctive element. This mask is made of a material capable of passing from an opaque state to a transparent state under the effect of an electric field. The passing of the mask to the transparent state thus enables to expose the distinctive element (photograph).

Document US 2008/198278 describes an object comprising a layer having an optical effect and capable of being masked by an upper opaque layer in the absence of electric current. Such an opaque upper layer may be formed of liquid crystals or of a photochromic material. It is made transparent by application of an electric current.

Just as the device described in document US 2006/0126001, the present invention relates to an object which can be authenticated comprising an authentication pattern which is not apparent in normal conditions of use.

### DISCUSSION OF THE INVENTION

The Applicant has developed an object capable of being authenticated comprising a cover enabling to conceal or to mask an authenticating pattern incorporated to the substrate. A detection device deactivates this cover to be able to detect the authenticating pattern, thus enabling to distinguish the object which can be authenticated from any counterfeit.

More specifically, the present invention relates to an object which can be authenticated comprising a substrate, said substrate containing at least one authenticating or identification pattern. The pattern is covered with a cover enabling to mask it and to expose it, the cover being capable of undergoing a physical or structural transformation capable of enabling to expose said pattern.

Further, the authenticating pattern is fluorescent and comprises fluorescent organic particles and/or fluorescent inorganic particles incorporated in the substrate of the object which can be authenticated.

The substrate of the object which can be authenticated according to the present invention is generally made of paper, or fabric, of polymer, of glass, or of metal.

The fluorescence of the authenticating pattern is provided by the presence of fluorochromes or fluorophores, that is, a chemical substance capable of emitting fluorescent light after excitation.

Inorganic fluorophores are generally age-resistant and have a low sensitivity to the different chemistries, thus making their incorporation easier. In the context of the present invention, they may advantageously be selected from the group comprising quantum dots, fluorite minerals such as adamite, hemimorphite, or calcite.

However, organic fluorophores are alterable along time and sensitive to the different incorporation chemistries. In the context of the present invention, they may advantageously be selected from the group comprising the family of cyanines such as Cy5, Cy3, or Alexa Fluor®.

Organic fluorophores have the advantage of being excitable at a single wavelength, unlike inorganic fluorophores, which have a wider absorption spectrum. Further, organic fluorophores may be used for a time-limited operation, given that they are alterable when they are not encapsulated. It will be within the abilities of those skilled in the art to select the adapted organic and/or inorganic fluorophores according to the authenticating pattern.

Generally, the authenticating pattern comprises fluorophores having a sufficient density to enable to detect the signal. It will be within the abilities of those skilled in the art to adjust the density according to the quantum efficiency of the selected particles, to the detector sensitivity, and to the available excitation power.

In a specific case, the actual substrate may be fluorescent and thus does not require the incorporation of fluorescent particles.

The cover of this object which can be authenticated comprises two possible stable states where the authenticating pattern is either (1) masked, or readable (2), and at least exposable, for example, by excitation.

The present invention comprises four main specific embodiments wherein the cover comprises a masking layer that may be:
a photochrome material, that is, a material capable of changing color under the effect of an external field. It is a material opaque to the authenticating pattern detection light; it becomes transparent under the effect of an external field. A photochrome substance has a different coloring according to the intensity of the field to which it is exposed. These are organic derivatives having the property of changing color under the influence of a radiation and of returning to its initial state in the absence of any radiation;
a material capable of physically deforming under the action of an external field.

This material can be assimilated to a plate deformable under the action of an external field;
a material comprising liquid crystals, passing from an opaque state to a transparent state under the effect of an external field;
a material comprising magnetic particles which scatter or gather under the action of a magnetic field.

Advantageously, the cover thickness ranges between 1 and 500 micrometers, to mask the authenticating pattern while enabling a rapid and abrupt transition from the masked state to the readable state and vice versa. Thus, the cover discretion is also provided.

In the object which can be authenticated according to the present invention, the cover masking the authenticating pattern is arranged to cover at least the substrate area comprising the authenticating pattern. The cover must be “open” so that the detection light can access said authenticating pattern. In this case, the masking layer is either transparent, or physically deformed.

It is known by those skilled in the art that in the presence of an external field, certain materials are physically deformed or change color by passing from opacity to transparency.

In the context of the present invention, the external field may be an electric current, an electric field, and/or a magnetic field. Indeed, photochromes are sensitive to light (electromagnetic field) while certain polymers are sensitive to the electric current (structure or conformation modification). On the other hand, the liquid crystals are sensitive to the electric field and mixtures containing magnetic particles are sensitive to the magnetic field.

Typically, the masking layer covering the authenticating pattern of the object which can be authenticated according to the invention especially comprises at least one material advantageously selected from the group comprising:
an ITO/WO₃/electrolyte/IrO₂/ITO (ITO=In₂O₃/SnO₂) electrochrome system in the case where the masking layer comprises a photochrome material; said electrolyte may be a protonic conduction anhydride polymer obtained by dissolution of orthophosphoric acid in a polymer, preferably branched polyethyleneimine (BPEI);
polymer actuators working in free air, preferably containing polyoxyethylene (POE) and PEDOT (poly(3,4-ethylenedioxythiophene) in the case where the masking layer comprises a material physically deformable under the effect of an external field;
7OCB (heptyloxycyanobiphenyl), N-(4-methoxybenzylidene)-4-butylaniline (MBBA), cholesteryl benzoate, para-azoxyanisole (PAA), or a silver metallogen in the case where the masking layer comprises liquid crystals;
magnetic balls in the case where the masking layer comprises magnetic particles; it may be a monodisperse emulsion of highly-magnetic polymer balls (iron oxide content of at least 50%), said balls being calibrated to 200±10 nanometers, such as for example sold by ADEMTECH.

Conversely to the present invention, document US 2006/0126001 discloses a concealable display. This device may thus raises issues due to the chemical incompatibility between the materials forming the authenticating pattern and those forming the cover, given that the display contains the “authenticating” image. The object which can be authenticated according to the present invention does not raise such issues. Indeed, in the present invention, a cover masks the authenticating pattern. The cover has to be actuated to expose the area comprising the authenticating pattern. A light (excitation) signal is then necessary to activate the specific signature (emission wavelengths) of the fluorophores or of the combination of fluorophores which are present.

According to a first specific embodiment, the cover of the object which can be authenticated according to the invention comprises:
a first layer of transparent conductive material deposited over at least the substrate area comprising the authenticating pattern;
a masking layer, made of a photochrome material, deposited over at least a portion of the transparent conductive material layer, to cover at least the substrate area comprising the authenticating pattern;
a second layer of transparent conductive material deposited over at least a portion of the photochrome material layer, without being in contact with the first layer of transparent conductive material.

According to a second specific embodiment, the cover of the object which can be authenticated according to the invention comprises:
a transparent anti-adhesive layer deposited over at least the substrate area comprising the authenticating pattern;
a first layer of transparent conductive material deposited over at least the area of the transparent anti-adhesive layer covering the substrate area comprising the authenticating pattern;
a masking layer made of a material physically deformable under the effect of an external field, deposited on the transparent conductive material layer, to cover the substrate area comprising the authenticating pattern;
a second layer of transparent conductive material deposited over at least a portion of the masking layer, without being in contact with the first layer of transparent conductive material.

In the foregoing embodiments, the transparent conductive layers, located on either side of the masking layer, are connected to electric contacts. These electric contacts, advantageously made of metal or of semiconductor material, form the electrodes.

Advantageously, the transparent conductive layers are made of ITO (In₂O₃/SnO₂), or PEDOT (poly(3,4-ethylenedioxythiophene).

According to a third specific embodiment, the cover of the object which can be authenticated according to the invention comprises:
a vertical polarization filter deposited over at least the substrate area comprising the authenticating pattern;
a glass with electrodes behaving as a vertical filter, deposited on the vertical polarization filter, where the electrodes may be made of IZO (In₂O₃/ZnO) or ITO (In₂O₃/SnO₂);
liquid crystals deposited on the glass with electrodes, to cover at least the substrate area comprising the authenticating pattern;
a glass with electrodes behaving as a horizontal filter deposited on the liquid crystals;
a horizontal filter to stop light or to let it through, deposited on the glass with electrodes;
a reflective surface, advantageously a thin metal or dielectric layer, deposited on the horizontal filter to stop light and let it through.

The cover according to the third specific embodiment relates to a liquid crystal display.

For any authenticating object formed according to one of the four above-mentioned embodiments, the detector must, simultaneously:
activate the cover, for example, by applying an electric current by means of electric probes; and
locally illuminating the substrate area comprising the authenticating pattern.

The present invention also relates to manufacturing methods associated with the four above-described specific embodiments.

For example, in the specific case where the object which can be authenticated, having its cover comprising a masking layer made of a material capable of changing color under the effect of an external field and having a fluorescent authenticating pattern, the manufacturing method comprises the steps of:
incorporating fluorescent particles in a substrate or, possibly, using a fluorescent substrate:
depositing a first layer of transparent conductive material over at least the substrate area comprising the authenticating pattern;
depositing a masking layer made of a photochrome material, over at least a portion of the transparent conductive material layer, to cover at least the substrate area comprising the authenticating pattern;
depositing a second layer of transparent conductive material over at least a portion of the photochrome material layer, without being in contact with the first layer of transparent conductive material.

The manufacturing method according to the second specific embodiment of an object which can be authenticated, having its cover comprising a masking layer made of a material capable of undergoing a deformation under the effect of an external field, and a fluorescent authenticating pattern, comprises the steps of:
incorporating fluorescent particles in a substrate or, possibly, using a fluorescent substrate;
depositing a transparent anti-adhesive layer over at least the substrate area comprising the authenticating pattern;
depositing a first layer of transparent conductive material over at least the area of the transparent anti-adhesive layer covering the substrate area comprising the authenticating pattern;
depositing a masking layer made of a material physically deformable under the effect of an external field on the transparent conductive material layer, to cover the substrate area comprising the authenticating pattern;
depositing a second layer of transparent conductive material over at least a portion of the masking layer, without being in contact with the first layer of transparent conductive material.

The manufacturing method according to the third specific embodiment of an object which can be authenticated, wherein the cover comprises a masking layer comprising liquid crystals capable of passing from an opaque state to a transparent state under the effect of an external field, comprising the steps of:
incorporating fluorescent particles in a substrate or, possibly, using a fluorescent substrate;
depositing a vertical polarization filter over at least the substrate area comprising the authenticating pattern;
depositing a glass with electrodes corresponding to the vertical filter on the vertical polarization filter;
depositing liquid crystals on the glass with electrodes corresponding to the vertical filter, to cover at least the substrate area comprising the authenticating pattern;
depositing a glass with electrodes corresponding to a horizontal filter on the liquid crystals;
depositing a horizontal filter to stop light and to let it through on the glass with electrodes corresponding to the horizontal filter;
depositing a reflective surface on the horizontal filter to stop light and let it through.

The manufacturing method according to the fourth specific embodiment of an object which can be authenticated wherein the cover comprises a masking layer comprising magnetic particles further comprises incorporating a material comprising magnetic particles.

The present invention also relates to the use of an object which can be authenticated such as described hereabove in an anti-counterfeiting system.

Without this being a limitation, the object which can be authenticated according to the present invention may be a bank card, a safety badge, a document, an identification document, luxury goods (jewelry, clothes, accessories . . . ), pharmaceutical products.

The present invention also relates to a method for authenticating an object comprising an authenticating pattern masked by a cover, wherein the cover is either physically deformed, or optically activated by means of an external field, advantageously by means of an electric current, of an electric field, and/or of a magnetic field, to enable to expose the authenticating pattern.

The advantages of the present invention over prior art especially comprise:
the possibility of locally exciting the substrate, thus enabling to decrease the quantity of fluorophores and thus to decrease the cost of the anti-counterfeiting system when the authenticating pattern is fluorescent;
the cover can only be activated by locally placing the electric probes. This system enables to accurately locate the anode and the cathode for the optical measurement. The probability of discovery of the presence of fluorophores by counterfeiters is thus decreased.

### DESCRIPTION OF THE DRAWINGS

The invention and the resulting advantages will better appear from the following non-limiting embodiments, in relation with the accompanying drawings, among which:

FIGS. 1A and 1B schematically show an object capable of being authenticated according to a first embodiment of the invention. According to this mode, the cover (13) comprises a masking layer made of photochrome or of liquid crystals. This masking layer becomes transparent under the effect of an external field as illustrated in FIG. 1B. The fluorescent particles (2) incorporated to the substrate (1) can thus emit fluorescence light, the excitation light being no longer stopped by the cover (13), which has become transparent.

FIGS. 2A and 2B schematically show an object capable of being authenticated according to a second embodiment of the invention. According to this mode, the cover (13) comprises a masking layer made of a deformable material. This masking layer is physically deformed under the effect of an external field as illustrated in FIG. 2B. The fluorescent particles (2) incorporated to the substrate (1) can thus emit fluorescence light, the excitation light being no longer stopped by the cover (13).

FIG. 3A schematically shows an optical detection authentication system according to prior art, wherein fluorescent particles (2), or fluorophores (2), are incorporated to a substrate (1).

FIG. 3B shows the emission of the fluorophores (2) of the authentication system according to prior art when they are submitted to an excitation.

FIG. 4A shows the cover of the object which can be authenticated according to the invention when it comprises a photochrome masking layer (6). The layer of photochrome material, which is sensitive to the external field, is comprised between two transparent conductive layers (5). The two transparent conductive layers (5) are respectively connected to an anode (3) and to a cathode (4).

FIG. 4B shows the cover of the object which can be authenticated according to the invention when the masking layer (6) comprises liquid crystals. The masking layer (6) is comprised between two glasses with electrodes corresponding to the vertical (8) and horizontal (9) filters. These glasses are connected to electric contacts (4). The glass with electrode corresponding to the vertical filter (8) is covered with a (vertical) polarization filter (7). The glass with electrode corresponding to the horizontal filter (9) is covered with a horizontal filter which enables to stop light and to let it through (10). The latter is covered with a reflective surface (11).

FIGS. 5A to 5D show the successive steps of the forming of an object which can be authenticated provided with a cover comprising a photochrome material capable of passing from an opaque state of a transparent state under the effect of an external field.

FIGS. 6A to 6D show the successive steps of the forming of an object which can be authenticated provided with a cover comprising a material physically deformable under the effect of an external field.

FIGS. 7A to 7E show the successive steps of the forming of an object which can be authenticated provided with a cover comprising liquid crystals capable of passing from an opaque state to a transparent state under the effect of an external field.

FIGS. 8A, 8B, and 8C illustrate state 2 for which the simultaneous application of an electric current and/or of a magnetic field on the anode and the cathode of the cover is necessary to activate said cover. The activated cover (which has become transparent in FIGS. 8A and 8C or having lifted in FIG. 8B) enables to detect the authenticating pattern.

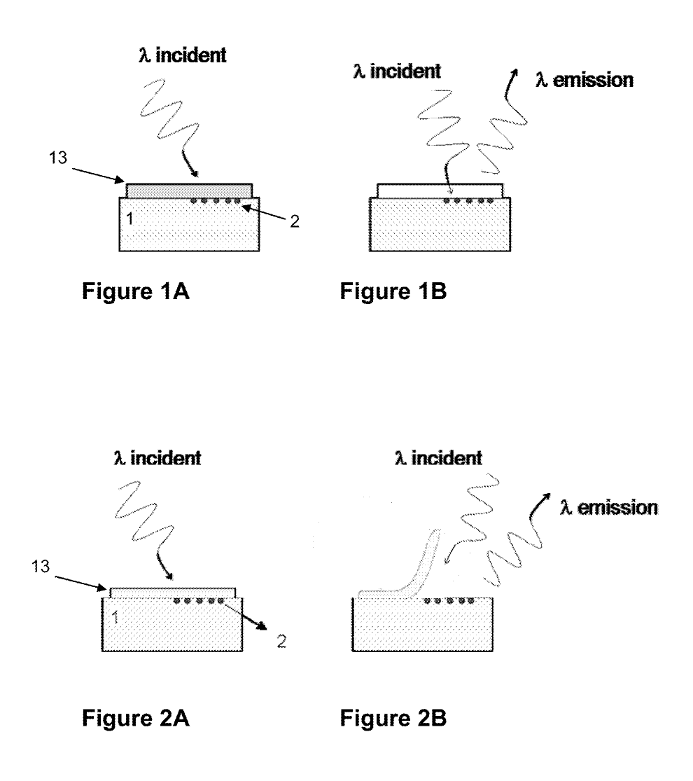

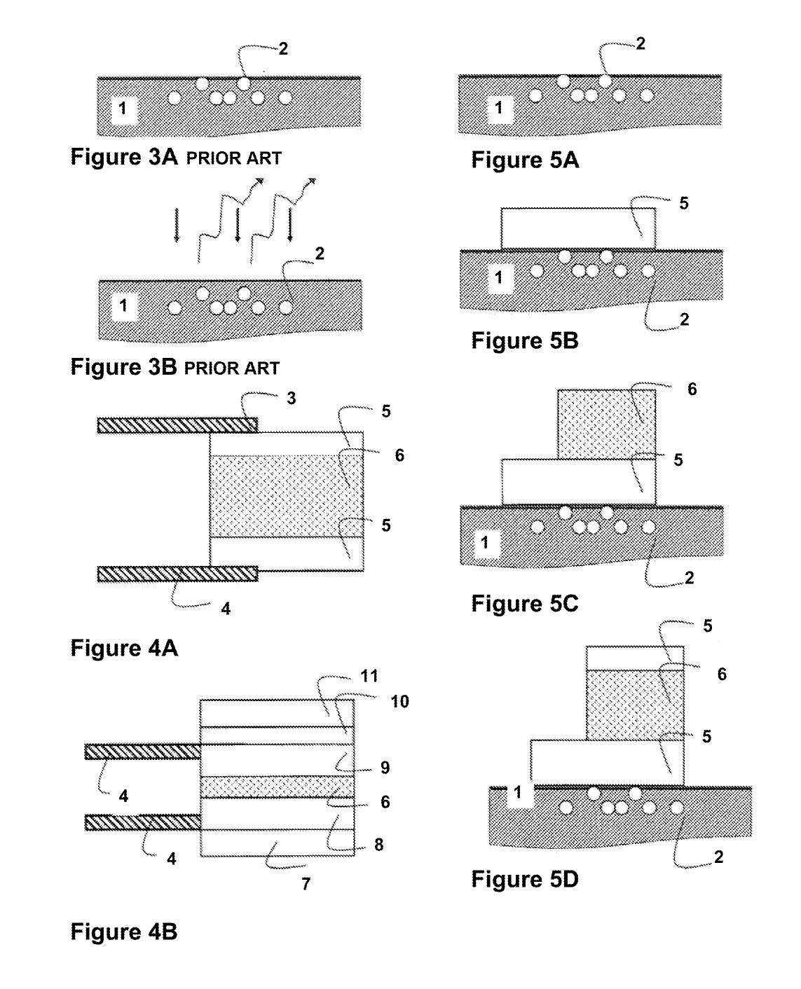

### DETAILED DESCRIPTION OF THE INVENTION

As already indicated, the present invention relates to an object which can be authenticated having its substrate comprising at least one authenticating or identification pattern, and where a cover enables to mask and to expose the substrate portion containing the authenticating pattern.

Advantageously, this object which can be authenticated may be formed according to one of the three preferred embodiments detailed hereafter, in the specific case where the authenticating pattern comprises fluorescent particles incorporated to the substrate.

### 1. Masking Layer Made of a Photochrome Material

The first specific embodiment relates to an object which can be authenticated having its cover comprising a photochrome material changing color under the effect of an external field. The device is prepared according to the following steps illustrated in FIGS. 5A to 5D:

In FIG. 5A, fluorophores (2) are incorporated to the substrate (1) to form the authenticating pattern.

The cover is formed during steps 5B to 5D:
the second step illustrated in FIG. 5B comprises depositing a transparent conductive material (5) over at least the substrate area comprising the authenticating pattern, and then etching it chemically or with a laser to give it the desired shape to obtain an electrode, preferably the anode;
in the third step, illustrated in FIG. 5C, a photochrome material is deposited on the transparent conductive layer to form masking layer (6), either by printing or full plate. The photochrome is then etched chemically or with a laser when it is intended to be located on the anode. The anode has to be exposed, advantageously by chemical etching or laser, to allow an electric contact;
the fourth and last step of this method is illustrated in FIG. 5D. It comprises depositing a transparent conductive material (5) on the masking layer (6) made of photochrome material. This second transparent conductive layer is then etched chemically or with a laser to the desired shape to obtain an electrode, preferably, the cathode. Of course, the anode and the cathode must be well separated to avoid any short-circuit.

### 2. Masking Layer Made of a Physically-Deformable Material

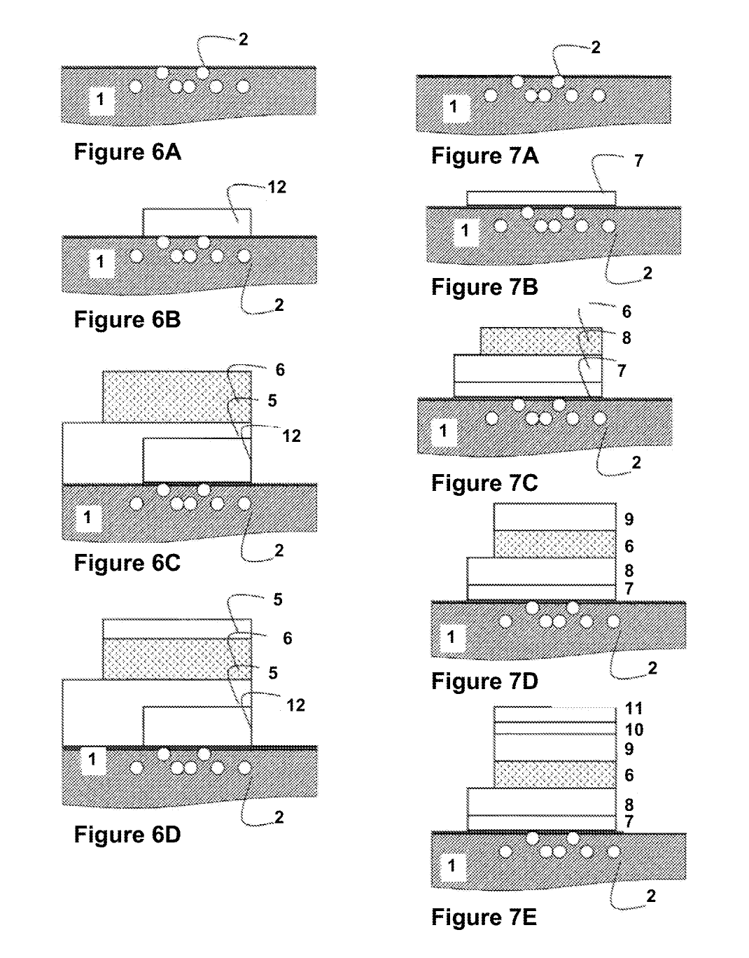

The second specific embodiment relates to an object which can be authenticated having its cover comprising a material physically deformable under the effect of an external field. The object which can be authenticated is prepared according to the following steps illustrated in FIGS. 6A to 6D.

In FIG. 6A, fluorophores (2) are incorporated to the substrate (1) to form the authenticating pattern.

The cover is formed during steps 6B to 6D:
during the second step illustrated in FIG. 6B, a layer called “transparent anti-adhesive layer” (12) is deposited at least on the area of the substrate (1) comprising the authenticating pattern. It enables the upper layers not to adhere to the substrate, at least over the area of the substrate (1) comprising the authenticating pattern. Thus, the cover may be lifted during the electric activation:
FIG. 6C illustrates the deposition of a transparent conductive material (5) which is then etched chemically or with a laser to the desired shape to obtain an electrode, preferably the anode. This layer partially bonds to the substrate. FIG. 6C also illustrates the deposition of the masking layer (6), made of a material physically deformable under the effect of an external field, either by printing, or full plate before being etched chemically or with a laser when it is intended to be located on the anode. The anode must be exposed to allow an electric contact.
FIG. 6D illustrates the deposition of a transparent conductive material (5) which is then etched chemically or with a laser to the desired shape to obtain the cathode. The anode and the cathode must be well separated to avoid any short-circuit.

### 3. Liquid Crystal Masking Layer

The third specific embodiment relates to an object which can be authenticated having its cover comprising liquid crystals. The device is prepared according to the following steps illustrated in FIGS. 7A to 7E:

In FIG. 7A, fluorophores (2) are incorporated to the substrate (1) to form the authenticating pattern.

The cover, which may be considered as a liquid crystal display, is formed during steps 7B to 7E:
FIG. 7B illustrates the deposition of a (vertical) polarization filter (7).
FIG. 7C illustrates the deposition of a glass with electrodes corresponding to the vertical filter (8) on the polarization filter (7);

FIG. 7C illustrates the liquid crystal deposition to form the masking layer (6), which deposition is performed by capillarity printing or by any other means, on the glass with electrodes (8);

FIG. 7D illustrates the deposition of a glass with electrodes corresponding to the horizontal filter (9) on the liquid crystal masking layer (6);

FIG. 7E illustrates the deposition of the horizontal filter to stop light/let it through (10), on the glass with electrodes (9);
FIG. 7E illustrates the deposition of a reflective surface (11) on the horizontal filter (10).

All these forming techniques are non-limiting examples. It will be within the abilities of those skilled in the art to use any appropriate technique, such as screen printing, rotogravure, pad printing.

In these three preferred embodiments, the cover activation should be performed simultaneously to the optical detection of the authenticating pattern (2).

At state 1, the substrate area (1) comprising the authenticating pattern is covered, and there is no possible detection of the presence of fluorophores.

FIGS. 5D, 6D, and 7E illustrate state 1 in which the cover covering the area of the substrate (1) comprising the authenticating pattern makes any measurement of the fluorophore photoluminescence impossible.

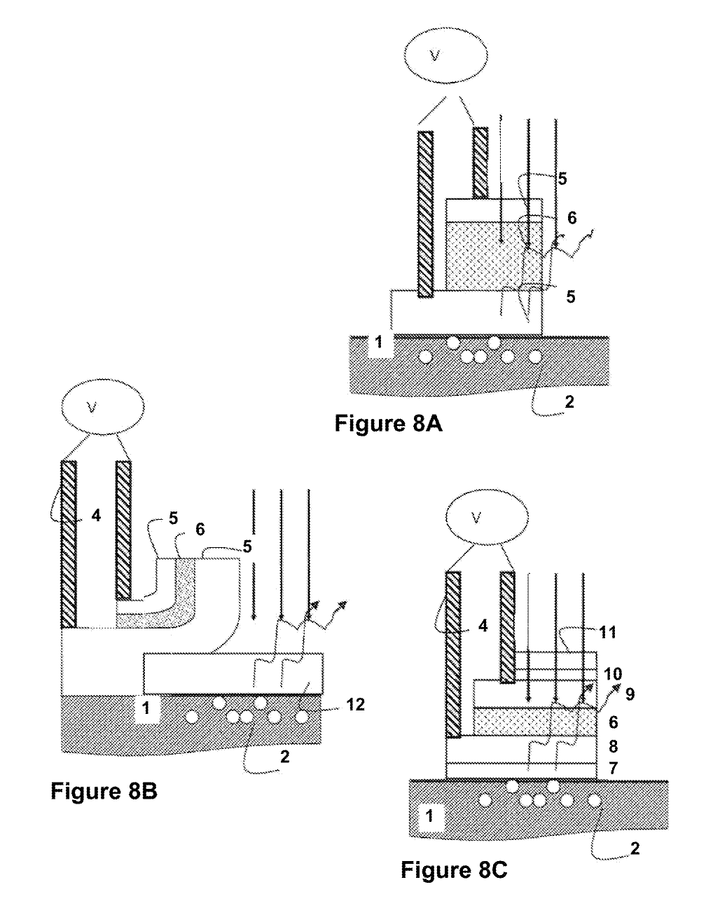

FIGS. 8A, 8B, and 8C illustrate state 2 for which the simultaneous application of an electric (or magnetic) current on the anode and the cathode of the cover is necessary to activate the cover. The activation of the cover (which has become transparent in FIGS. 8A and 8C or which has lifted in FIG. 8B) allows the “reading” of an optical measurement to detect the presence of fluorophores (2), which is a token of traceability.

1. An object which can be authenticated comprising a substrate, said substrate containing at least one authenticating or identification pattern covered with a cover enabling to mask and to expose said authenticating pattern, the cover being capable of undergoing a physical or structural transformation capable of enabling to expose said pattern, said authenticating pattern being fluorescent and comprising fluorescent organic particles and/or inorganic fluorescent particles incorporated in the substrate.

2. The object which can be authenticated of claim 1, wherein the cover comprises a masking layer made of a material capable of changing color under the action of an electric current, of an electric and/or magnetic field.

3. The object which can be authenticated of claim 1, wherein the cover comprises a masking layer made of a material physically deformable under the action of an electric current, of an electric field, and/or of a magnetic field.

4. The object which can be authenticated of claim 1, wherein the cover comprises a masking layer comprising liquid crystals.

5. The object which can be authenticated of claim 1, wherein the cover comprises a masking layer comprising magnetic particles.

6. The object which can be authenticated of claim 1, wherein the cover comprises two transparent conductive layers located on either side of the masking layer.

7. The object which can be authenticated of claim 6, wherein the transparent conductive layers are made of ITO or PEDOT.

8. The object which can be authenticated of claim 1, wherein the substrate is made of paper, of fabric, of polymer, of glass, or of metal.

9. A use of the object which can be authenticated of claim 1 in an anti-counterfeiting system.

10. A method for authenticating an object wherein said object comprises an authenticating pattern masked by a cover according to claim 1, wherein said cover is physically deformed under the action of an electric current, of an electric field, and/or of a magnetic field, to enable to expose the authenticating pattern.

11. A method for authenticating an object wherein said object comprises an authenticating pattern masked by a cover according to claim 1, wherein said cover is optically activated by means of an external field, advantageously by means of an electric current, of an electric field, and/or of a magnetic field, to enable to expose the authenticating pattern.
